(19) United States
(12) Patent Application Publication
(10) Pub. No.: US 2013/0312024 A1
(43) Pub. Date: Nov. 21, 2013

(54) DATA DISTRIBUTION TO DEVICES

(71) Applicant: CAMBRIDGE SILICON RADIO LIMITED, Cambridge (GB)

(72) Inventor: Paul Morris, Cambridge (GB)

(73) Assignee: Cambridge Silicon Radio Limited, Cambridge (GB)

(21) Appl. No.: 13/873,056

(22) Filed: Apr. 29, 2013

(30) Foreign Application Priority Data
May 17, 2012 (GB) 1208670.8

(51) Int. Cl. H04N 21/81

(52) U.S. Cl. CPC H04N 21/812
USPC 725/23

(57) ABSTRACT

A system and method for the distribution of data to wireless devices. In particular, a system and method in which voucher data is received by a media viewer in conjunction with media data, and transmitted to a wireless device for use in an electronic payment system.

### CROSS-REFERENCE TO RELATED APPLICATIONS

This application claims priority to U.K. Patent Application Serial No. 1208670.8 filed on May 17, 2012, the disclosure of which is herein incorporated by reference in its entirety.

### TECHNICAL FIELD

This disclosure relates to systems and methods for the distribution of data in conjunction with media.

### BACKGROUND

Companies commonly wish to make special offers available to only selected individuals. This is typically achieved by issuing vouchers to the individuals they wish to benefit from the offers. This enables control of the number of beneficiaries of a special offer, and allows a company to link the issue of a voucher to an act by the receiving individual.

Historically, physical vouchers have been utilised to indicate that a given individual is entitled to receive a special offer. However, such a method of distribution is inefficient as it requires the printing and distribution of physical vouchers. Furthermore, it can be difficult to link the distribution of vouchers to certain media, for example gaming or broadcast media. Various methods have been attempted but are typically inefficient. For example, a telephone number may be displayed in broadcast media for a viewer to call to request the issue of a voucher.

Vouchers may also be distributed in electronic form. For example, vouchers may be sent as emailed documents or code numbers, or may be provided by electronic payment providers in the form of an electronic voucher within the electronic payment system. However, similar difficulties in issuing the vouchers to those encountered with physical vouchers remain.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method of distributing voucher data, comprising the steps of receiving voucher data at a media viewer in conjunction with media data, the media data being for display on the media viewer; transmitting the voucher data from the media viewer to a portable electronic device via at least one wireless link; and storing the voucher data at the portable electronic device.

The step of transmitting may comprise transmitting the voucher data from the media viewer to a control device, and subsequently transmitting the voucher data from the remote control device to the portable electronic device.

The step of transmitting may comprise transmitting the voucher data directly from the media viewer to the portable electronic device.

The voucher data may be transferred from the control device to the portable electronic device using an NFC wireless link.

The step of transmitting the voucher data may be initiated by a user input to a control device for the media viewer or to the portable electronic device.

The step of transmitting the voucher data to the control device may occur without user input, and the step of transmitting the voucher data from the control device to the portable electronic device is initiated by user input to the control device for the media viewer or to the portable electronic device.

The voucher data may be stored at the portable electronic device in relation to an electronic payment system.

The voucher data may be stored in a secure memory area related to an NFC electronic payment system.

The voucher data may represent a special offer redeemable by a user of the portable electronic device.

The voucher data may be a link to data representing a special offer redeemable by a user of the portable electronic device.

The media viewer may be a television set and the media and voucher data are received as a television program broadcast.

The media viewer may be a gaming system and the media and voucher data are received from a game data storage device.

There is also provided a system for receiving voucher data in conjunction with media data, comprising a media viewer configured to receive voucher data and media data; the media viewer comprising a wireless interface configured to transmit the voucher data to a portable electronic device.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a schematic block diagram of as system for the distribution of special offers in conjunction with media;

FIG. 2 shows a flow chart of a method of distributing special offers in conjunction with media;

FIG. 3 shows a schematic block diagram of as system for the distribution of special offers in conjunction with media; and

FIG. 4 shows a schematic block diagram of an exemplary computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

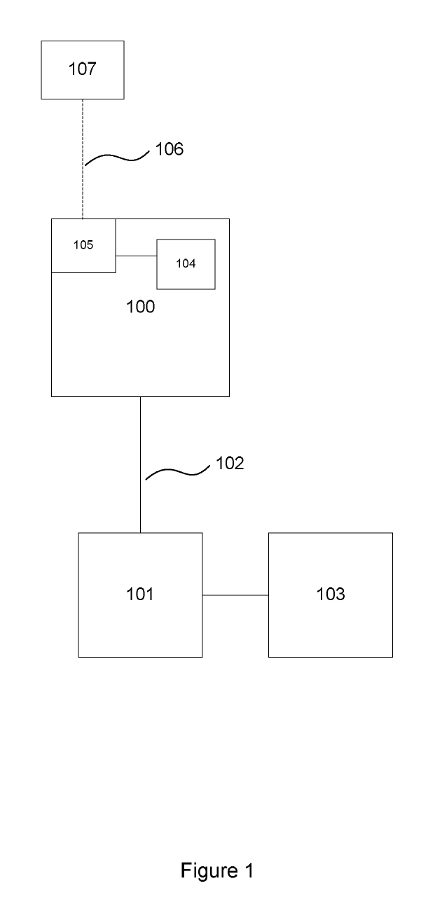

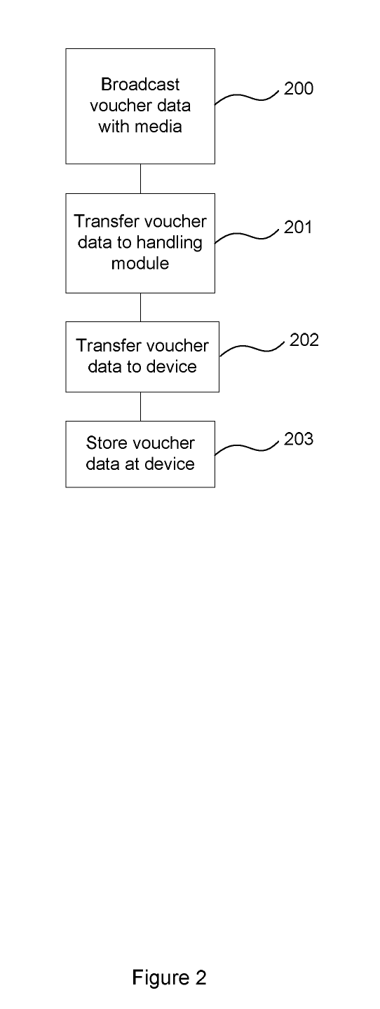

FIG. 1 shows a schematic diagram of a system for the distribution of special offers through a media broadcast system. The system enables special offers to be linked to broadcast media and viewers to receive a voucher for that special offer in a straightforward and efficient manner. FIG. 2 shows a flow chart of a method of issuing special offers utilising the system of FIG. 1.

In FIG. 1, a media viewer 100 receives media content from a broadcast system 101. In an embodiment media viewer 100 may be a television set which receives media via a digital television broadcast 102. Broadcast system 101 is coupled to a voucher management system 103. Voucher management system 103 stores data on vouchers that companies may wish to make available in conjunction with a broadcast 102 from broadcast system 101.

To link a voucher to a broadcast 102, data describing the voucher is retrieved by the broadcast system 101 from the voucher management system 103. At an appropriate position in the broadcast the data describing the voucher is broadcast (block 201) with the media broadcast 102. For example the data may be transmitted in a data channel of a digital TV broadcast channel, or alternatively the data could be sent via the internet to the media viewer 100. The data is received in conjunction with the media data, typically at the same time, but in certain embodiments a time offset may be present. The media data and/or voucher data may include identifiers to link the data.

Media viewer 100 is provided with a voucher handling module 104. When data describing a voucher is received at media viewer 100, that data is passed (block 201) to voucher handling module 104. Voucher handling module 104 may be provided as computer software running on a processing system of the media viewer, or may be provided as a hardware system. Any implementation providing the functionality described herein may be utilised.

Media viewer 100 has a wireless interface 105 which is in communication with at least the voucher handling module 104. Wireless interface 105 is provided to communicate with portable devices, for example mobile telephones via a wireless link. The wireless link may take any form, for example it may be an NFC system, Wi-Fi (802.11), or Bluetooth. The wireless interface 105 may provide a variety of types of wireless link, or the media viewer 100 may comprise a plurality of wireless interfaces 105 of different types.

In order to issue a voucher for which data has been received at voucher handling module 104 a wireless connection 106 is established between the wireless interface 105 and a portable device 107. The method of establishing the connection will depend on the wireless technology being utilised. For example, if the wireless link is an NFC link the connection may be established by ‘tapping’ the portable device at the location of the wireless interface 105 on the media viewer. If the link is a Wi-Fi or Bluetooth link the connection may be established using known techniques at the instigation of either the wireless interface 105 or the portable device 107. For example, the viewer may select an option on a remote control for the media viewer, on a user interface of the media viewer, or on the portable device, indicating they wish a voucher to be transferred, which causes the link 106 to be established and the voucher data to be transferred.

Once the wireless connection 106 is established the voucher data is transferred (block 202) from the voucher handling module 104 to the portable device 107. The portable device 107 may be provided with a voucher handling module to accept, store (block 203), and make available the vouchers or the voucher may be stored in any appropriate form. For example, an application may be installed on the device to handle the voucher data. In a particular embodiment, the voucher data is received by device 107 and stored in an electronic payment application provided on the device 107. For example, the device 107 may be provided with an NFC interface and a electronic payment application configured to utilise that interface for electronic payments. The voucher details may be stored in a secure storage area associated with the NFC or electronic payment system or in conjunction with an application utilising that payment system.

After storage on the device 107 the voucher is available for use by the user of that device. For example, the voucher may be used as part of the electronic payment system, may be displayed on a screen of the device to a shop assistant, or may be transferred electronically, for example by email or through a web interface, to a vendor with whom an electronic order is being made. For example, where the voucher is part of an electronic payment system it may be utilised when payment is made utilising an NFC payment.

The method and system described above thus enable the transmission of a voucher to a user in conjunction with the broadcast of media. The voucher is directly transferred to their mobile device, for example a mobile telephone, using wireless technology and is then available for use. User input to obtain and use the voucher is minimised, which may improve take-up and utilisation of vouchers.

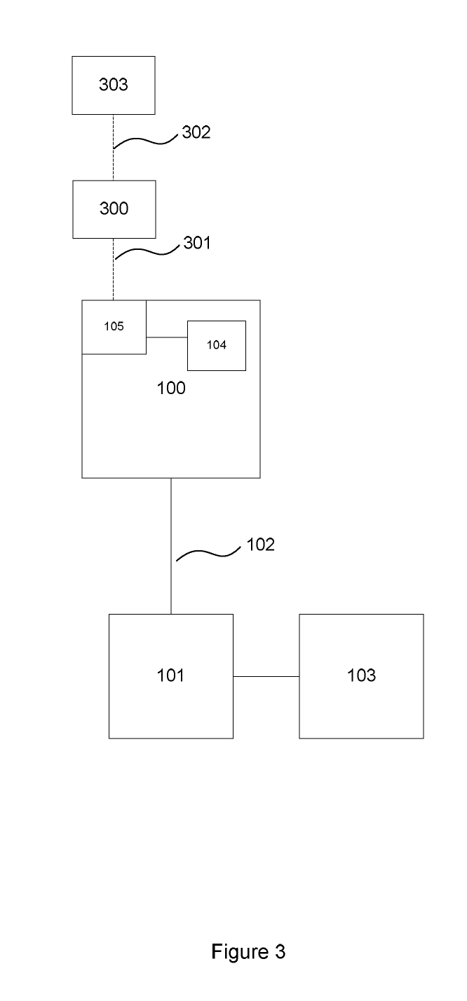

In an embodiment the voucher data is not transferred directly to the device 107, but is transferred via an intermediary device, for example a remote control. FIG. 3 shows a schematic block diagram of this embodiment.

In the system of FIG. 3, a first wireless link 301 is established between the wireless interface 105 and a remote control 300 associated with the media viewer 100. The voucher data is transferred to the remote control 300 from the voucher handling module 104 and stored, at least temporarily, at the remote control 300. The voucher data may be transferred when the data is received at the voucher handling module 104 and stored at that remote control for later use. Alternatively, the voucher data may be transferred to the remote control in response to user input. For example, the remote control may be provided with a button to cause the system to transfer the voucher data, or a gesture on or movement of the remote control may cause the transfer. For example, the user may press a button on the remote control 300 to request a voucher that has been displayed in media being viewed. In response to that button press the remote control 300 requests the voucher data which is transferred to the remote control 300. Transferring voucher data to the remote control when it is received by the voucher handling system 104 may provide a more convenient system as all voucher is available at the remote control, however this may be provide less efficient power usage due to the transmission and storage of vouchers that may not be desired.

The first wireless link 301 may be provided utilising any wireless communications system including those described hereinbefore.

To transfer the voucher data to a portable device 303, a second wireless link 302 is established between the remote control 300 and a portable device 303. The voucher data is transferred from the remote control 300 to the portable device 303 via the second wireless link 302, as described above for the transfer from the media viewer to a portable device in relation FIGS. 1 and 2. For example, where the remote control is NFC enabled, an NFC enabled portable device may be tapped on the remote control to establish an NFC link.

The two-step transfer process described in relation to FIG. 3 may be more convenient for a user as it is usual for the remote control 300 to be kept close to the user while viewing media. Vouchers can be transferred to the remote control 300, and then at a convenient time transferred to the portable device 303. The transfer to the device 303 may be initiated by actions on the remote control 300 or the device 303. For example, a user may utilise an application on the device 303 to request vouchers from the remote control, or a button may be pressed on the remote control to cause the transfer of voucher data.

As noted hereinbefore, vouchers may be provided with a period within which they must be claimed. The system may verify that a voucher is still valid before transferring it from the media viewer 100 to the remote control 300, and from the remote control 300 to device 303.

The above disclosure has been principally in the context of the media viewer being a television set. However, the media viewer may also be similar devices such as a gaming console or computer configured to view media. Although such systems may be configured to operate according to the principles described above, certain modifications may be required. For example, in a gaming console the media being displayed/played may not be received in a broadcast from a remote broadcaster, but may originate at a media store, for example a CD, at the gaming console. The principles described above apply equally to such a system, but the media and voucher data are received/generated from a local source rather than remotely. Similarly, the remote control would be replaced by a gaming controller.

In the above description the voucher data itself has been transferred to the remote control and portable device. In alternative embodiments a link to a voucher may be provided. For example the voucher data may be a link which when accessed on the portable device provides the user with the voucher. Alternatively, the voucher data may be a link which when transferred to the mobile device causes the mobile device to access and download the actual voucher data automatically.

A number of embodiments for the collection of voucher data in association with media being viewed, and the transfer of that voucher data to portable devices for later use, have been described. As will be appreciated variations on the specifically described embodiments fall with the disclosure of this application. For example, various combinations of wireless protocols may be utilised. The orders in which the various steps and transfers are described are not limiting and are provided as examples to explain the principles of operation. Various examples of initiating wireless links and transfers have been described, but these are not restrictive. Any combination of button presses, movements, or gestures may be utilised on any of the components of the system to initiate any of the actions and steps described herein, as appropriate for the particular component. Each component may be provided with an appropriate user interface to indicate the options available and allow the user to make their required selection.

An example of broadcasting the voucher data in a data stream associated with a digital TV broadcast signal has been provided for example. Any other method of transmitting voucher data in time-association with media may be utilised. In embodiments the voucher data may be transmitted separately from the media data, with an indication of the relation of the voucher data to the media data for processing at the receiver. Furthermore in certain embodiments, for example where the media viewer is a gaming system, the media and voucher data may be stored on a data carrier and received by the gaming system from the that data carrier rather than from a broadcast.

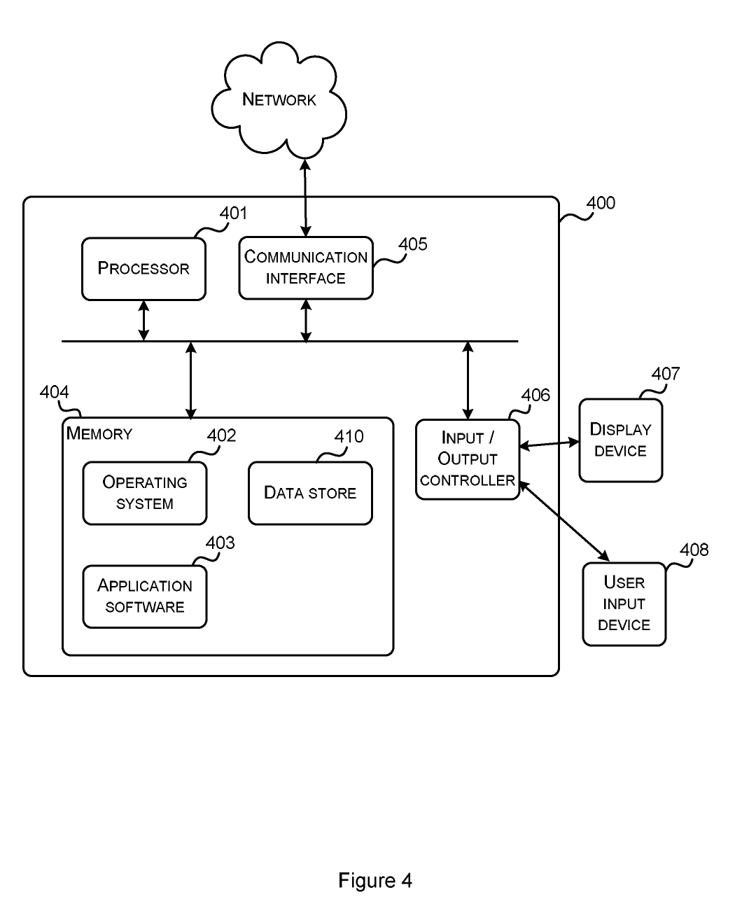

An example of the portable device being a mobile telephone has been provided, but this is not restrictive. The portable device may be any electronic device capable of implementing the functions of this disclosure, for example a phone, tablet computer, portable computer or NFC tag. The portable device may therefore be any device which is capable of receiving data over a wireless link and storing the voucher, a general example of which is shown schematically in FIG. 4 (as will be appreciated not all features shown in FIG. 4 are necessarily present in a suitable device). The general principles shown by FIG. 4 are also applicable to other components of the system which may be implemented as computing-based devices, for example the media viewer and remote control.

Computing-based device 400 comprises one or more processors 401 which may be microprocessors, controllers or any other suitable type of processors for processing computer executable instructions to control the operation of the device in order to run applications, such as an electronic payment application, media display system, or gaming system. In some examples, for example where a system on a chip architecture is used, the processors 401 may include one or more fixed function blocks (also referred to as accelerators) which implement a parts of the methods of operation of the mobile device or applications described herein in hardware (rather than software or firmware). Platform software comprising an operating system 402 or any other suitable platform software may be provided at the computing-based device to enable application software 403 to be executed on the device.

The computer executable instructions may be provided using any computer-readable media that is accessible by computing based device 400. Computer-readable media may include, for example, computer storage media such as memory 404 and communications media. Computer storage media, such as memory 404, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 404) is shown within the computing-based device 400 it will be appreciated that the storage may be distributed or located remotely and accessed via a network or other communication link (e.g. using communication interface 405).

The computing-based device 400 also comprises an input/output controller 406 arranged to output display information to a display device 4307 which may be separate from or integral to the computing-based device 400. The display information may provide a graphical user interface. The input/output controller 406 is also arranged to receive and process input from one or more devices, such as a user input device 408 (e.g. a touch screen, controller or keypad).

In an embodiment the display device 407 may also act as the user input device 408 if it is a touch sensitive display device. The computing-based device may also be provided with other functionality as is known for such devices. For example, the communication interface 405 may comprise a radio interface to a mobile telephone or other wireless communications system such an NFC communications interface, and a microphone, speaker, and camera may be provided for voice and video calling.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of distributing voucher data, comprising the steps of
receiving voucher data at a media viewer in conjunction with media data, the media data being for display on the media viewer;
transmitting the voucher data from the media viewer to a portable electronic device via at least one wireless link; and
storing the voucher data at the portable electronic device.

2. A method according to claim 1, wherein the step of transmitting comprises transmitting the voucher data from the media viewer to a control device, and subsequently transmitting the voucher data from the remote control device to the portable electronic device.

3. A method according to claim 1, wherein the step of transmitting comprises transmitting the voucher data directly from the media viewer to the portable electronic device.

4. A method according to claim 2, wherein the voucher data is transferred from the control device to the portable electronic device using an NFC wireless link.

5. A method according to claim 1, wherein the step of transmitting the voucher data is initiated by a user input to a control device for the media viewer or to the portable electronic device.

6. A method according to claim 2, wherein the step of transmitting the voucher data to the control device occurs without user input, and the step of transmitting the voucher data from the control device to the portable electronic device is initiated by user input to the control device for the media viewer or to the portable electronic device.

8. A method according to claim 1, wherein the voucher data is stored at the portable electronic device in relation to an electronic payment system.

9. A method according to claim 8, wherein the voucher data is stored in a secure memory area related to an NFC electronic payment system.

10. A method according to claim 1, wherein the voucher data represents a special offer redeemable by a user of the portable electronic device.

11. A method according to claim 1, wherein the voucher data is a link to data representing a special offer redeemable by a user of the portable electronic device.

12. A method according to claim 1, wherein the media viewer is a television set and the media and voucher data are received as a television program broadcast.

13. A method according to claim 1, wherein the media viewer is a gaming system and the media and voucher data are received from a game data storage device.

14. A system for receiving voucher data in conjunction with media data, comprising
a media viewer for receiving voucher data and media data;
a wireless interface configured to transmit the voucher data to a portable electronic device.
